(19) United States
(12) Patent Application Publication
(10) Pub. No.: US 2026/0358795 A1
(43) Pub. Date: Nov. 12, 2026

(54) METHOD AND DEVICE FOR PREDICTING DRIFT OF HARDWARE

(71) Applicant: NaTran, Bois Colombes (FR)

(72) Inventor: Florent BRISSAUD, Bois Colombes (FR)

(21) Appl. No.: 19/125,750

(22) PCT Filed: Dec. 8, 2023
(86) PCT No.: PCT/EP2023/084953

§ 371 Date: Apr. 30, 2025

(30) Foreign Application Priority Data
Dec. 14, 2022 (FR) FR2213384

(51) Int. Cl. G05B 23/02; G06N 20/00

(52) U.S. Cl. CPC G05B 23/024; G06N 20/00

(57) ABSTRACT

The method (70) for predicting drift of a physical quantity comprises a step (71) of an operator intervening on hardware causing a variation in the value of this physical quantity and a step (72, 75) of regularly measuring this physical quantity. The method additionally comprises:
a first step (73) of analysing the values for a first predetermined duration following the intervention,
a calibration step (74) that delivers at least one limit value of this physical quantity, on the basis of the result of this first analysis,
a second step (76) of analysing the values for a second sliding duration,
a step (77) of extrapolating a future value of this physical quantity, on the basis of the result of this second analysis, and
a step (78, 79) of determining whether the future extrapolated value crosses one of the limit values within a predetermined future time interval and, if so, a step (80) of triggering an alert.

### TECHNICAL FIELD OF THE INVENTION

This invention relates to a method and a device for predicting the drift of hardware. It applies, in particular, to items of regulator hardware (for example, for regulating a flow rate, pressure, temperature or level) which are subject to drift (for example, valves, pressure reducers, pumps or compressors) and whose measurements of the quantities regulated are available “continuously” or at fairly short intervals of time relative to the hardware's dynamics of drift. More specifically, the present invention applies to a gas regulating station.

### PRIOR STATE OF THE ART

Anomaly detection algorithms operate with a learning phase which requires a large amount of data, both measurements of physical quantities (e.g. pressure) and anomalies (e.g. poor regulation), in order to establish a link between these data. However, in practice the number of anomalies collected is too small and the hardware considered is too varied to enable adequate learning for this type of algorithm.

Time series prediction algorithms are designed in particular to predict periodic phenomena (e.g. seasonal). Nevertheless, the drifts observed on industrial hardware are inconsistent with such models. In addition, external interventions such as maintenance actions performed by operators (e.g. correcting bias, changing the regulator settings) create discontinuities in the time series, which limit their learning potentials.

In the specific case of gas regulating stations, the operators intervene regularly on these stations, in particular to correct drifts and/or change regulator settings, with the following drawbacks:
hardware drifts potentially too large between two external interventions, with certain implications concerning the availability of the installations, safety and/or the environment;
external interventions on the hardware that are not always necessary; and
on-call external interventions, for example at night or on public holidays, which are more costly.

Document US 2022/197271 is known, which describes a method for predicting drift of a physical quantity regulated by an item of regulation hardware. This method comprises a step of statistically analysing measurements of this physical quantity following a readjustment by the regulation hardware.

### DESCRIPTION OF THE INVENTION

The present invention aims to remedy all or part of these drawbacks. To this end, according to a first aspect, the present invention envisages a method for predicting drift of a physical quantity, which method comprises a step of an operator intervening on an item of hardware causing a variation in the value of this physical quantity, and a step of regularly measuring this physical quantity that delivers a set of values of this physical quantity, which method additionally comprises:
a first step of analysing the values of this physical quantity during a first predetermined duration following the intervention step,
a calibration step that delivers at least one limit value of this physical quantity, on the basis of the result of this first analysis,
a second step of analysing the values of this physical quantity during a second sliding duration after the intervention step,
a step of extrapolating a future value of this physical quantity, on the basis of the result of this second analysis, and
a step of determining whether the future extrapolated value crosses one of the limit values within a predetermined future time interval and, if so, a step of triggering an alert.

Thanks to these provisions, without using learning over a long period, the method automatically determines a criterion of abnormality for a hardware drift, after an external intervention on the hardware, and then a prediction of the occurrence of this abnormality. This method therefore makes it possible to decide on a new preventive intervention to avoid the occurrence of too large a drift. It also makes it possible to intervene on the hardware only when a drift is predicted. Lastly, it avoids, or at least reduces, on-call operator interventions, which are more costly.

Note that the first duration, during which the first analysis is performed, is predetermined by default. However, this can be extended according to the results, for example if the variance is too large, in order to obtain a more “robust” calibration. Similarly, the second sliding duration can be dynamic and adjusted according to at least one indicator of the “stability” of the trends. With respect to the alert triggered, this can take the form of emails sent automatically to the operations teams concerned.

In some embodiments, during the first analysis step, a mean and standard deviation of the values of the physical quantity are calculated and, during the calibration step, at least one limit value is equal to the calculated mean, to which a product of the measured standard deviation by a predetermined number is added or subtracted. The mean calculated in this way can also be increased or decreased according to a certain percentage, especially when the limit values of the physical quantity can be determined by a margin of error around the regulation setpoint.

The product of the standard deviation by a predetermined number is added to the mean, in the case of the maximum limit value, and subtracted from the mean, in the case of the minimum limit value. Thanks to these provisions, the detection criterion implemented depends on the initial stability of the values of the physical quantity monitored.

In some embodiments, during the second analysis step, a linear regression of the values of the physical quantity is performed.

In some embodiments, during the second analysis step, a non-linear regression is performed, for example utilising an exponential smoothing type of model or AutoRegressive Integrated Moving Average (ARIMA).

In some embodiments, during the second analysis step, only a selection of the values of the physical quantity are processed during the second sliding duration after the intervention step.

Thanks to each of these provisions, a measurement of the trends of the physical quantity is obtained, without using significant computing power. A single server can therefore utilise the method on a large number of hardware items subject to drift. In practice, the method that is the subject of the invention can be utilised once a day, in order to not overload the communication networks. In addition, if there are alerts, they can all be sent together, for example at the beginning of the day, which facilitates the organisation of the day's maintenance schedules.

In some embodiments, the method comprises, prior to the intervention, a step of delivering values of the physical quantity measured on hardware items similar to the hardware on which the intervention is performed and/or on the hardware on which the intervention is performed, to a machine learning model trained to extrapolate a value of the physical quantity, on the basis of the measurements made on this hardware and, during the second analysis and extrapolation steps, this trained machine learning model is utilised to obtain the future value.

In this way one benefits from the extrapolation precision obtained by means of a trained machine learning model.

In some embodiments, the method comprises, prior to the intervention, a step of delivering values of the physical quantity measured on hardware items similar to the hardware on which the intervention is performed and/or on the hardware on which the intervention is performed, to a machine learning model trained to extrapolate a value of the physical quantity, on the basis of the measurements made on this hardware and, during the first analysis and calibration steps, this trained machine learning model is utilised to obtain at least one limit value.

A determination of limit value(s) and/or a prediction is therefore realised based on artificial intelligence. Note that the predictions can be improved in this way by performing the learning process with other data available, for example gas consumption or meteorological data.

In some embodiments, the learning involving previous regressions and alerts confirmed or invalidated by the maintenance operators makes it possible to define an indicator of confidence for future alerts.

In some embodiments, during the extrapolation step, a future value is extrapolated for the end of a third duration following the second duration.

A horizon is therefore set, equal to this third duration. At this horizon, i.e. on a predetermined expiry time, it is determined whether the physical quantity risks becoming abnormal, i.e. crossing a limit value. For example, this horizon is a number of hours or days. Note that this horizon can vary according to the availability of a maintenance operator, so that the prediction of an abnormal drift can prompt a preventive intervention by an operator.

In some embodiments, the third duration is dependent on the day and/or time of the second duration.

For example, this horizon is a regular working day for a maintenance operator. This horizon is therefore set to cover the last two days of the week and public holidays so as to be on a working day. The operator can therefore intervene before those days that would require an on-call intervention.

In some embodiments, during the extrapolation step, one measures a duration following the second duration before a limit value is crossed.

In this way, the predicted duration before the drift becomes abnormal is evaluated and means an operator's intervention can be scheduled well in advance. This duration reflects a degree of urgency for the maintenance operation. In particular, if several items of hardware are the subject of a drift prediction according to the method that is the subject of the invention, the order of the next operator's interventions can be determined based on this degree of urgency and, possibly, other criteria, such as the severity of the drift depending on the hardware involved (e.g. whether or not there is an emergency regulator line or according to the size of the flow rates concerned), the accessibility of the hardware, closeness to the other items of hardware, or the availability of a maintenance operator.

According to a second aspect, the present invention envisions a device for predicting drift of a physical quantity following an operator intervening on hardware causing a variation in the value of this physical quantity, which device comprises a means for regularly measuring this physical quantity that delivers a set of values of this physical quantity, characterised in that it additionally comprises:
a first means for analysing the values during a first predetermined duration following the intervention,
a calibration means that delivers at least one limit value of this physical quantity, on the basis of the result of this first analysis,
a second means for analysing the values of this physical quantity during a second sliding duration after the intervention,
a means for extrapolating a future value of this physical quantity, on the basis of the result of this second analysis, and
a means for triggering an alert if the future extrapolated value crosses one of the limit values within a predetermined future time interval.

As the particular features, advantages and aims of this device are similar to those of the method that is the subject of the invention, they are not repeated here.

In some embodiments, the hardware is an item of regulation hardware configured to regulate a flow rate, pressure, temperature or level.

In some embodiments, the hardware is an item of regulation hardware configured to regulate a physical quantity of a valve, pressure reducer, pump or compressor.

The inventor has determined that the invention applies particularly well to the prediction of these physical quantities and/or the regulation of this regulation hardware.

According to a third aspect, the present invention envisions an expansion station for a gas, which comprises a device that is the subject of the invention, wherein the hardware regulates the pressure on output from a regulator valve.

The inventor has observed the effectiveness of the implementation of the invention for such an expansion station.

### BRIEF DESCRIPTION OF THE FIGURES

Other advantages, aims and particular features of the invention will become apparent from the non-limiting description that follows of at least one particular embodiment of the method and device that are the subjects of the invention, with reference to drawings included in an appendix, wherein:

FIG. 1 represents, schematically, a particular embodiment of a device that is the subject of the invention installed in a gas expansion and/or delivery station,

FIG. 2 represents a change in gas pressure on output from a gas expansion and/or delivery station, and a determination of limit values for gas pressure changes on output from a gas expansion and/or delivery station,

FIG. 3 represents a first prediction of gas pressure changes on output from a gas expansion and/or delivery station,

FIG. 4 represents a second prediction of gas pressure changes on output from a gas expansion and/or delivery station,

FIG. 5 represents a third prediction of gas pressure changes on output from a gas expansion and/or delivery station,

FIG. 6 represents, in the form of a logical diagram, steps in a particular embodiment of the invention applies to the regulation of pressure on output from an expansion station,

FIG. 7 represents an interface for monitoring a network of gas expansion and/or delivery stations, and

FIG. 8 represents, in the form of a logic diagram, steps in a particular embodiment of the method that is the subject of the invention.

### DESCRIPTION OF THE EMBODIMENTS

The present description is given in a non-limiting way, in which each characteristic of an embodiment can be combined with any other characteristic of any other embodiment in an advantageous way.

As natural gas and/or biomethane is transported at high pressure (for example 70 bar) and distributed in town at low pressure (for example 5 bar), the purpose of an expansion station is to expand the gas from high pressure to low pressure. At each supply point of the network and at each delivery point, metering systems make it possible to measure the quantities of natural gas and/or biomethane that transit at these points.

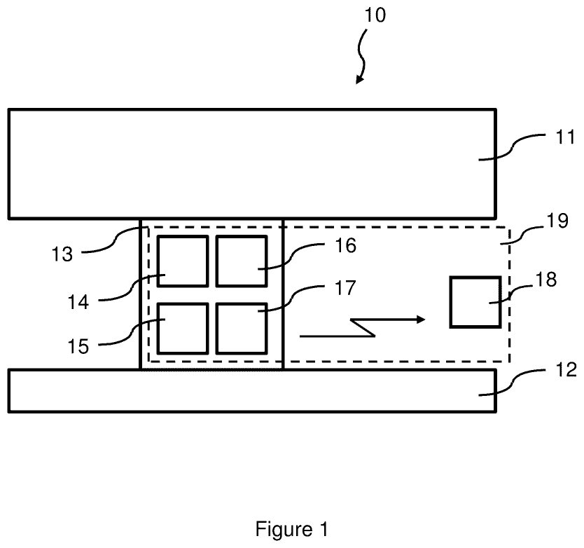

FIG. 1 shows an installation 10 comprising an expansion station 13. The function of this expansion station 13 is to reduce the pressure of the gas distributed by a general network 11 to levels of pressure that can be used by the different types of customers, for example domestic, tertiary or industrial, connected to a distribution network 12. The metering and regulating station (“MRS”) is an installation used to regulate the pressure and metering of natural gas. In addition to the upstream 11 and downstream 12 gas pipes, this station 13 comprises various devices: pressure regulator hardware 14, pressure measurement sensor 15 downstream from the regulator 14, meter (not shown), volume corrector (not shown), safety valve (not shown), valves (not shown), filter (not shown), data processing device 16 and data transmission device 17.

The pressure regulator 14 is subject to a drift that has the effect of varying the downstream pressure in the downstream gas pipe 12. However, this downstream pressure must remain within a range of values, between a minimum value ensuring the operation of the customers' installations and a maximum value avoiding the risks of leaks at these installations or of the pipe 12 breaking. A maintenance operation, on site or controlled remotely, makes it possible to correct this drift by modifying the operating parameter values of the pressure regulator 14. The present invention makes it possible to anticipate the need for such maintenance operations.

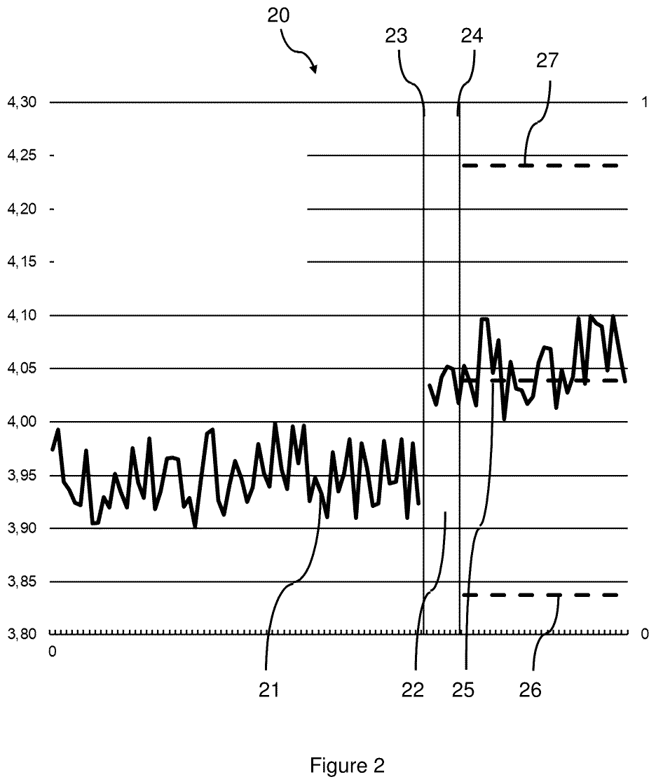

FIG. 2 shows a time-based graph 20 of pressure downstream from a pressure regulator. The successive values of the pressure are shown by the curve 21. These successive values are obtained either by continuously measuring the downstream pressure, or by regularly measuring this pressure. At an instant 23, an operator performs an intervention on the regulator, which results in a discontinuity in the curve 21. In the case shown in FIG. 2, it concerns an increase in the downstream pressure.

For a first predetermined duration 22 following the instant 23 of the intervention, lasting to instant 24, a first analysis of the measured values of the pressure is performed. This first duration is also called the “calibration window”. This first analysis is, for example, statistical, and determines and delivers a mean value 25, a standard deviation for this pressure and a maximum amplitude of these variations.

A lower limit value 26 and an upper limit value 27 are set, on the basis of the result of the first analysis. According to a first example, the lower limit value 26 is equal to the mean value less a predetermined percentage, for example five percent. According to a second example, the lower limit value 26 is equal to the mean value less a predetermined number of times the standard deviation, for example three times. In a variant, the mean calculated in this way can be increased or decreased according to a certain percentage, especially when the limit values of the physical quantity can be determined by a margin of error around the regulation setpoint. According to a third example, the lower limit value 26 is equal to the mean value less a predetermined proportion of the amplitude, for example a half-amplitude, and a predetermined percentage of the mean value or a predetermined number of times the standard deviation. Of course, any other combination of the results of the first analysis can be used to set the lower limit value 26. Similarly, the upper limit value 27 is determined in one of these ways by replacing a reduction by an increase.

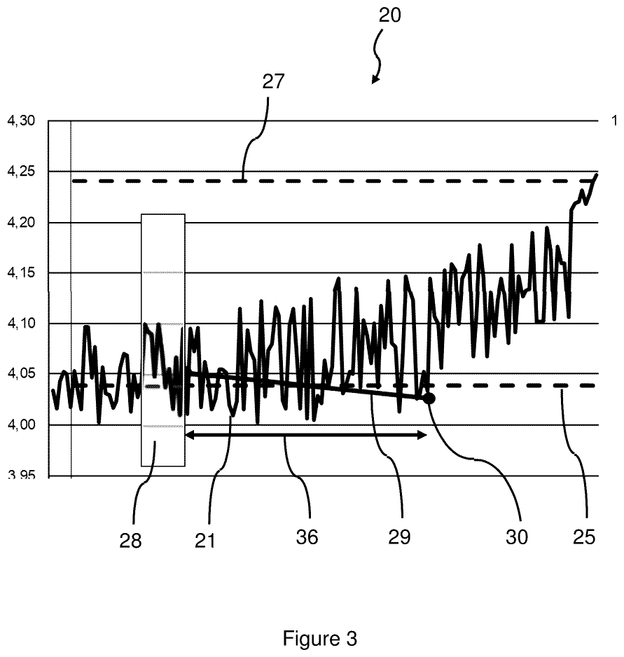

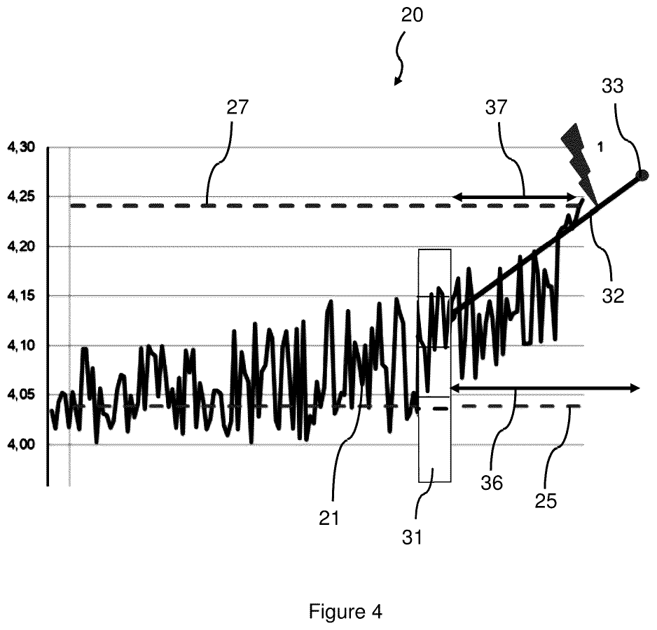

As shown in FIGS. 3 and 4, during a second sliding duration, 28 in FIGS. 3 and 31 in FIG. 4, after the intervention step, a second analysis of the pressure values is also performed. This second analysis is, for example, statistical, and delivers a time function, 29 in FIGS. 3 and 32 in FIG. 4, that can extend after the end of the second sliding duration. This second sliding duration 28 or 31 is also called the “sliding window”. It ends at the current instant. Note that the second duration can overlap the first duration, as long as the duration between the intervention step and the current instant is less than the sum of the first duration and the second duration.

The pressure values after this sliding window are therefore not known during the processing of the pressure values in this sliding window. This time-based function modelling pressure changes therefore enables the pressure value to be extrapolated into the future. For example, the second analysis performs a regression, for example linear, as in the embodiment shown in FIGS. 3 and 4. The time-based modelling function is therefore a linear function, whose curve 29 or 32 is a straight line. In another example, the second analysis performs a non-linear regression, for example it utilises an exponential smoothing type of model or AutoRegressive Integrated Moving Average (ARIMA). In some embodiments, this analysis step is performed on a selection of the values of the physical quantity during the second sliding duration, 28 or 31, after the intervention step. For example, daily percentiles are processed and the second analysis only involves the extreme values for each day.

On the basis of this time function, a future value, 30 in FIGS. 3 and 33 in FIG. 4, is extrapolated for the pressure. In the embodiment shown in FIGS. 3 and 4, the future value, 30 or 33, is the value of the time function, 29 or 32, after a third predetermined duration 36 starting at the end of the sliding window. This third predetermined duration is also called the “horizon”. In other embodiments, this future value is equal to one of the limit values, 26 and 27, and the duration 37 is determined between the end of the sliding window and the instant when the time function, 29 or 32, is equal to one of the limit values, 26 and 27.

If the future extrapolated value crosses one of the limit values, 26 or 27, within a predetermined future time interval, the device 13 triggers a local or remote alert. In the case where a horizon 36 is used, this condition is met if the future value 30 or 33 is greater than the upper limit value 27 or less than the lower limit value 26. In the case where the duration 37 is determined before a limit value 26 or 27 is crossed, this condition is met if this duration is less than the duration of the predetermined future time interval.

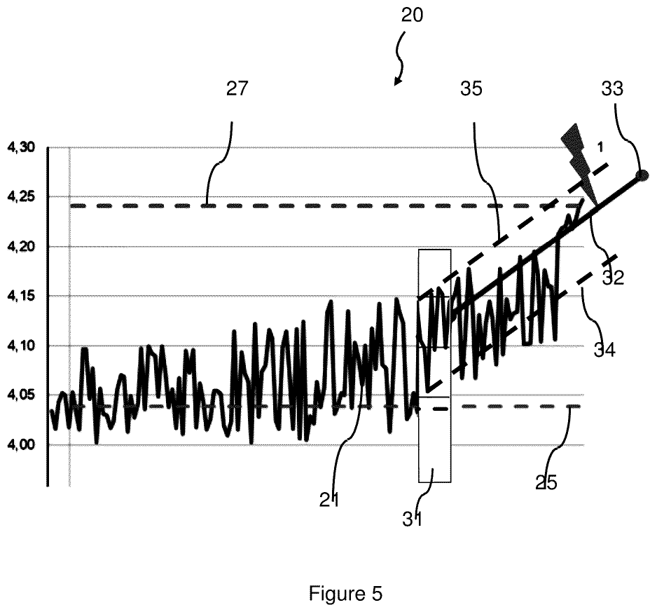

In the variant shown in FIG. 5, instead of or in addition to the time function 32, the same processing is performed on at least one of:
the time function 34, with the same slope as the function 32 but shifted so that all the pressure values in the sliding window are greater than the value of the function 34,
the time function 35, with the same slope as the function 32 but shifted so that all the pressure values in the sliding window are less than the value of the function 35.

This variant makes it possible to take into account the amplitude of the pressure variation observed in the sliding window 31. In some variants, time functions are applied that are shifted from function 32 by adding or subtracting a half-amplitude of the pressure variation in the sliding window. Other variants are based on a predetermined number of times the standard deviation of the pressure values in the sliding window 31, and/or an amplitude or standard deviation calculated over another duration than that of the sliding window 31.

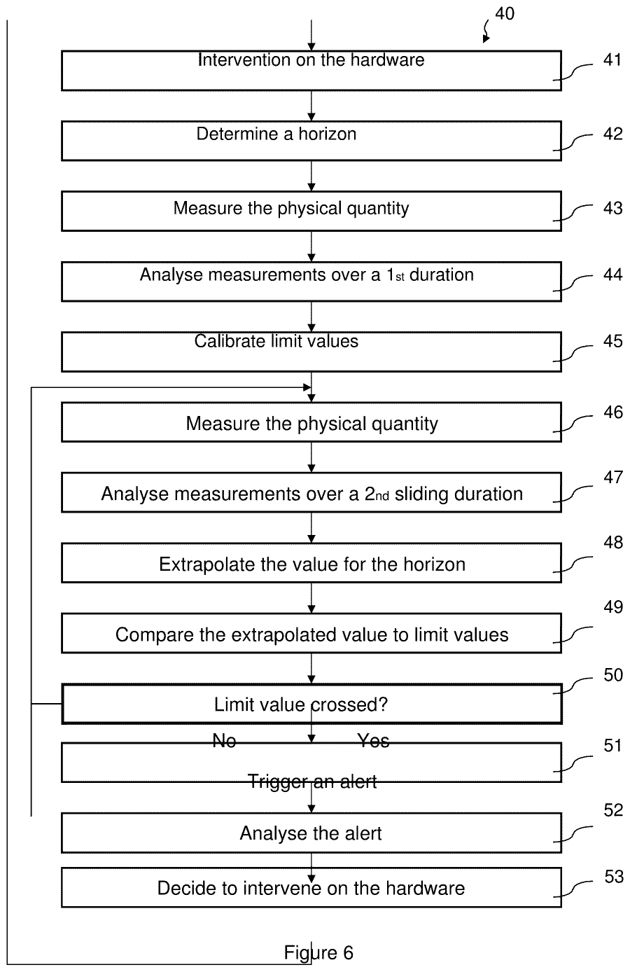

As shown in FIG. 6, an embodiment 40 of the method for predicting drift of a physical quantity controlled by an item of hardware, for example an item of regulation hardware, comprises different steps starting at the end of an intervention 41 on the hardware. During a step 42, a horizon is determined. In some embodiments, this horizon is fixed, for example equal to one or more days. In some embodiments, this horizon varies according to the time for intervention by an operator, depending on his place of work, residence or immediate geographic position and the travel time required to reach the hardware that is the subject of the invention. In some embodiments, this horizon varies over time, for example it depends on the day and/or time of the sliding window, such that this horizon, greater than a minimum value, for example one day, does not end outside the intervention times (for example between 8 am and 6 pm), and not on a Saturday, Sunday or a public holiday.

During a step 43, the pressure is regularly measured downstream from the regulation device. This regular measurement delivers a set of values of this pressure.

During a step 44, a first step is performed of analysing the values of this pressure during a first predetermined duration following the intervention, i.e. the calibration window.

Note that the first analysis duration is predetermined by default, but it is possible to extend it depending on the results, for example if the variance is too large, in order to obtain a more “robust” calibration. In some variants, the step 44 therefore comprises a determination of the variance in the pressure value and, if this variance is greater than a predetermined value, an extension of this first duration, the first analysis therefore being performed over the extended first duration.

During a step 45, a calibration step is performed that delivers at least one limit value of this physical quantity, on the basis of the result of this first analysis.

During a step 46, the regular measurement of the pressure downstream from the regulation device continues.

During a step 47, a second step is performed of analysing the values of this pressure during a sliding window after the intervention step.

Note that the second analysis duration is predetermined by default, but it is possible to extend it depending on an instability indicator in order to obtain a more “robust” second analysis. In some variants, the step 47 therefore comprises a determination of the instability of the trend in the change in the pressure value and, if this instability is greater than a predetermined value, an extension of this second duration, the second analysis therefore being performed over the extended first duration.

Note that the second duration can overlap the first duration, as long as the duration between the intervention step and the current instant is less than the sum of the first duration and the second duration. Since the steps 44 and 47 are independent, the step 47 can therefore be completed before the step 44 and step 45.

During a step 48, a step is performed of extrapolating a future value of the pressure at the horizon, on the basis of the result of this second analysis.

During a step 49, the future value of the pressure at the horizon is compared to each limit value. During a step 50, it is determined whether one of the limit values has been crossed by the extrapolation at the horizon. If the result of step 50 is negative, one goes back to step 46. If the result of step 50 is positive, i.e. if the future extrapolated value crosses one of the limit values within the horizon (predetermined future time interval), during a step 51, an alert is triggered remotely, and possibly locally, and one goes back to step 46. At the same time, during a step 52, the alert is analysed remotely. For example, it is determined whether the weather conditions could explain this alert and whether the weather forecast predicts a return to normal conditions. Lastly, during a step 53, an intervention decision is made, for example a scheduling of interventions on several items of hardware, based on the shortest route to carry out the interventions. Then, one goes back to step 41, once this intervention has been carried out.

In particular, if several items of hardware are the subject of a drift prediction according to the method that is the subject of the invention, the order of the next operator's interventions can be determined based on this degree of urgency and, possibly, other criteria, such as the severity of the drift depending on the hardware involved (e.g. whether or not there is an emergency regulator line or according to the size of the flow rates concerned), the accessibility of the hardware, closeness to the other items of hardware, or the availability of a maintenance operator.

In the embodiment shown in FIG. 6, during the first analysis step 44, the mean and deviation of the values of the physical quantity are calculated and, during the calibration step 45, at least one limit value is equal to the calculated mean plus the product of the measured standard deviation by a predetermined number.

In the embodiment shown in FIG. 6, during the second analysis step 47, a regression, for example linear, of the values of the physical quantity is performed.

In the embodiment shown in FIG. 6, during the extrapolation step 48, a future value is extrapolated for a horizon, i.e. a third duration following the second duration. Preferably, the horizon depends on the day and/or time of the sliding window. In a variant, during the extrapolation step 48, one measures a duration following the second duration before a limit value is crossed.

In the variants described below, a machine learning model is used. It is therefore possible to improve the determination of the limit values and/or the extrapolation by performing the learning with the pressure values, but also with other data available, for example gas consumption on the network or meteorological data.

In these variants, the method comprises, prior to the intervention, a step of delivering values of the physical quantity measured on hardware items similar to the hardware on which the intervention is performed and/or on the hardware on which the intervention is performed, to a machine learning model trained to extrapolate a value of the physical quantity, on the basis of the measurements made on this hardware.

The extrapolation is, of course, even more reliable when the measured values used for the learning process were measured on the hardware 14 to which the method is applied and/or on similar hardware having a similar operating environment. Similarly, the extrapolation is more reliable if the measured values are measured after an intervention by an operator and are supplemented with values measured before this intervention. In the latter case, during the utilisation of the trained machine learning model, it is supplied, in addition to the pressure measurements made after the intervention, with pressure measurements made before the intervention.

In a first variant, during the first analysis step 44 and calibration step 45, this trained machine learning model is utilised to obtain at least one limit value.

In a second variant, possibly combined with the first variant, during the second analysis step 47 and extrapolation step 48, this trained machine learning model is utilised.

This machine learning model is, for example, a recurrent neural network (RNN) or convolutional neural network (CNN). These neural networks are especially suitable for the cases in which additional information is incorporated, such as consumption and meteorological data.

In some embodiments, the learning concerning previous regressions and alerts confirmed or invalidated by the maintenance operators makes it possible to define an indicator of confidence for future alerts, according to known techniques.

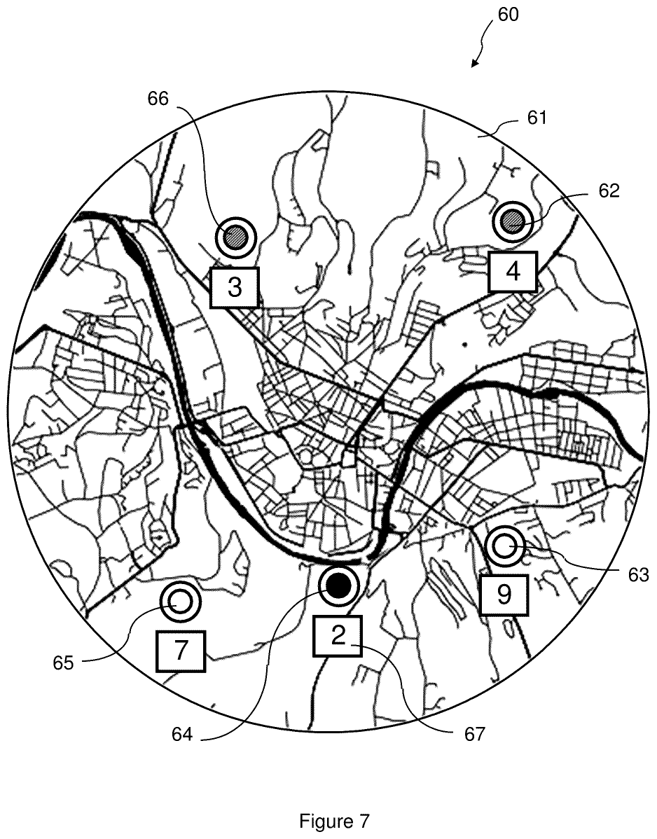

As shown in FIG. 7, an interface 60 for viewing alerts can take the form of a map 61 which shows the positions of hardware items subject to interventions, 62 to 66. The representation of each of these hardware items, by an outer circle, has an associated colour representation depicting the duration before a limit value, obtained by the calibration of this hardware, is crossed. In FIG. 7, the darker the central circle, the shorter this duration is. A numerical representation 67 of this duration is also displayed below the representation of each hardware item. This double representation of the urgency of an intervention allows an operator to prepare a round of interventions on the hardware items 62 to 66 shown on the map 61, for example based on the urgency and access routes for these hardware items.

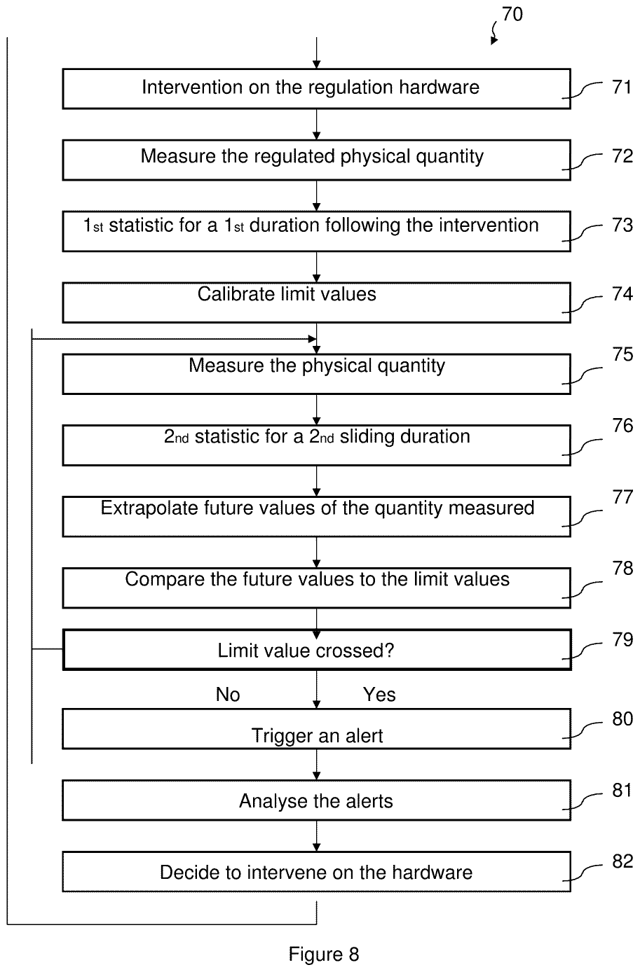

FIG. 8 shows a particular embodiment 70 of a method that is the subject of the invention, more generally applied to a physical quantity controlled by an item of hardware, for example an item of regulation hardware. During a step 71, an operator performs an intervention on this hardware causing a variation in the value of this physical quantity.

During a step 72, this physical quantity is regularly measured, delivering a set of values of this physical quantity.

During a step 73, a first analysis is performed analysing the values of this physical quantity during a first predetermined duration following the intervention step.

During a step 74, a calibration is performed, delivering at least one limit value of this physical quantity, on the basis of the result of this first analysis.

During a step 75, the regular measurement of the value of this physical quantity continues.

During a step 76, a second analysis is performed analysing the values of this physical quantity during a second sliding duration after the intervention step.

Note that the second duration can overlap the first duration, as long as the duration between the intervention step and the current instant is less than the sum of the first duration and the second duration. Since the steps 73 and 76 are independent, the step 76 can therefore be completed before the step 73 and step 74.

During a step 77, a future value of this physical quantity is extrapolated, on the basis of the result of this second analysis.

During a step 78, the future values are compared to the limit values.

During a step 79, it is determined whether one of the limit values has been crossed. If the result of step 79 is positive, i.e. if the future extrapolated value crosses one of the limit values within the horizon (predetermined future time interval), then during a step 80, an alert is triggered and one goes back to step 75. At the same time, during a step 81, the alert is analysed remotely. Lastly, during a step 82, an intervention decision is made. Then, one goes back to step 71, once this intervention has been carried out.

Of course, all the technical characteristics, embodiments and variants disclosed with reference to FIGS. 1 to 6 apply to the method 60 shown in FIG. 7.

Returning to FIG. 1, the hardware is an item of regulation hardware, and more specifically a pressure regulator 14. The sensor 15 performs the continuous measurement of the pressure downstream from the pressure regulator 14. The data transmission device 17 transmits to a remote server 18 the pressure values measured by the sensor 15 and/or the results of the processing performed by the data processing device 16.

More generally, a device 19 that is the subject of the invention applies to an item of industrial hardware. In particular, this hardware can be configured to regulate a measurable physical quantity, for example a flow rate, pressure, temperature or level. For example, this hardware is configured to regulate a physical quantity of a regulator valve, pressure reducer, pump or compressor, in particular for gas.

The data processing device 16 and the remote server 18, which form part of the device 19 that is the subject of the invention, are jointly configured to perform the steps of the method that is the subject of the invention and form, by the utilisation of at least one computer program, at least:
a means 15 for regularly measuring this physical quantity that delivers a set of values of this physical quantity, characterised in that it also comprises:
a first means, 16 and/or 18, for analysing the values of this physical quantity during a first predetermined duration 22 following the intervention,
a calibration means, 16 and/or 18, that delivers at least one limit value, 26 and/or 27, of this physical quantity, on the basis of the result of this first analysis,
a second means, 16 and/or 18, for analysing the values of this physical quantity during a second sliding duration, 28 and/or 31, after the intervention,
a means, 16 and/or 18, for extrapolating a future value, 30 and/or 33, of this physical quantity, on the basis of the result of this second analysis, and
a means, 16 and/or 18, for triggering an alert if the future extrapolated value crosses one of the limit values within a predetermined future time interval 36.

1. A method for predicting drift of a physical quantity comprising a step of an operator intervening on an item of hardware causing a variation in the value of this physical quantity and a step of regularly measuring this physical quantity that delivers a set of values of this physical quantity, additionally: comprising:
a first step of analysing the values of this physical quantity during a first predetermined duration following the intervention step,
a calibration step that delivers at least one limit value of this physical quantity, on the basis of the result of this first analysis,
a second step of analysing the values of this physical quantity during a second sliding duration after the intervention step,
a step of extrapolating a future value of this physical quantity, on the basis of the result of this second analysis, and
a step of determining whether the future extrapolated value crosses one of the limit values within a predetermined future time interval and, if so, a step of triggering an alert.

2. The method according to claim 1 wherein, during the first analysis step, a mean and standard deviation of the values of the physical quantity are calculated and, during the calibration step, at least one limit value is equal to the calculated mean, to which a product of the measured standard deviation by a predetermined number is added or subtracted.

3. The method according to claim 1, wherein, during the second analysis step, a linear regression of the values of the physical quantity is performed.

4. The method according to claim 1, wherein, during the second analysis step, a non-linear regression is performed, for example utilising an exponential smoothing type of model or AutoRegressive Integrated Moving Average (ARIMA).

5. The method according to claim 1, wherein, during the second analysis step, only a selection of the values of the physical quantity are processed during the second sliding duration after the intervention step.

6. The method according to claim 1, which comprises, prior to the intervention, a step of delivering values of the physical quantity measured on hardware items similar to the hardware on which the intervention is performed and/or on the hardware on which the intervention is performed, to a machine learning model trained to extrapolate a value of the physical quantity, on the basis of the measurements made on this hardware and, during the second analysis step and extrapolation step, this trained machine learning model is utilised to obtain the future value.

7. The method according to claim 1, which comprises, prior to the intervention a step of delivering values of the physical quantity measured on hardware items similar to the hardware on which the intervention is performed and/or on the hardware on which the intervention is performed, to a machine learning model trained to extrapolate a value of the physical quantity, on the basis of the measurements made on this hardware and, during the first analysis and calibration steps, this trained machine learning model is utilised to obtain at least one limit value.

8. The method according to claim 6, which comprises a step of an operator confirming or invalidating the alert, the trained machine learning model being configured to determine an indicator of confidence for future alerts.

9. The method according to claim 1, wherein, during the extrapolation step, a future value is extrapolated for the end of a third duration following the second duration.

10. The method according to claim 9, wherein the third duration is dependent on the day and/or time of the second duration.

11. The method according to claim 1, wherein, during the extrapolation step, one measures a duration following the second duration before a limit value is crossed.

12. A device for predicting drift of a physical quantity following an operator intervening on hardware causing a variation in the value of this physical quantity, which device comprises—a means for regularly measuring this physical quantity that delivers a set of values of this physical quantity, also comprising:
a first means for analysing the values during a first predetermined duration following the intervention,
a calibration step that delivers at least one limit value of this physical quantity, on the basis of the result of this first analysis,
a second means for analysing the values of this physical quantity during a second sliding duration after the intervention,
a step of extrapolating a future value of this physical quantity, on the basis of the result of this second analysis, and
a means for triggering an alert if the future extrapolated value crosses one of the limit values within a predetermined future time interval.

13. The device according to claim 12, wherein the hardware is an item of regulation hardware configured to regulate a flow rate, pressure, temperature or level.

14. The device according to claim 12, wherein the hardware is an item of regulation hardware configured to regulate a physical quantity of a valve, pressure reducer, pump or compressor.

15. A gas expansion station comprising a device according to claim 12, wherein the hardware regulates the pressure on output from a regulator valve.
